(19) United States
(12) Patent Application Publication
(10) Pub. No.: US 2026/0156562 A1
(43) Pub. Date: Jun. 4, 2026

(54) LOGICAL NETWORK CONFIGURATION

(71) Applicant: Nokia Technologies Oy, Espoo (FI)

(72) Inventor: Alessio CASATI, WEST MOLESEY (GB)

(21) Appl. No.: 19/127,935

(22) PCT Filed: Nov. 10, 2023
(86) PCT No.: PCT/EP2023/081483

§ 371 Date: May 7, 2025

(30) Foreign Application Priority Data
Dec. 20, 2022 (GB) 2219221.5

(51) Int. Cl. H04W 48/16; H04W 48/18

(52) U.S. Cl. CPC H04W 48/16; H04W 48/18

(57) ABSTRACT

A method for logical network configuration is provided. The method comprises, at an apparatus, receiving, from a mobile network entity, human readable service, HRS, information and storing the received HRS information. The HRS information indicates, for at least one logical network available to the apparatus, a HRS name of a service associated with the at least one logical network. The method further comprises reading, from the received HRS information, the HRS name of the service associated with the at least one logical network currently used by the apparatus or available in a cell where the apparatus is camping on or that the apparatus can detect or in a tracking area or list of tracking areas or cells, or in the whole PLMN.

### FIELD

The subject matter disclosed herein generally relates to wireless communications and, more particularly, to logical network configuration.

### BACKGROUND

The next generation wireless communication system 5G/NR enables the support of logical networks over physical network infrastructure. While it is possible to detect today which network a mobile communication device is using, it is not possible to detect what logical network a mobile communication device is using actively. In addition, in some specific application domains, like public safety or enterprise, the set of applications that can run is conditional to experiencing connectivity offered by a certain logical network or set of logical networks.

A logical network, as defined by the Third Generation Partnership Project (3GPP) is also referred to as a network slice or single network slice selection assistance information (S-NSSAI) that provides specific network capabilities and network characteristics (TS 23.501). Those network slices may only use specific radio bearers and/or specific dedicated frequency bands and may need to redirect the mobile communication device to the dedicated frequency band(s).

The concept of configuring a human readable network name exists today where a public land mobile network (PLMN) ID (e.g. a mobile country code and mobile network code) is mapped to a network name, so the end user can detect which PLMN cell a mobile communication device is currently camping on.

### LIST OF ABBREVIATIONS

In the present disclosure, the following abbreviations are used and should be understood in accordance with the given definitions
AMF Access and Mobility Management Function
APN Access Point Name
DL Downlink
DNN Data Network Name
DRB Data Radio Bearer
EPS Evolved Packet System/4G
HRSI Human Readable Service Information
MME Mobility Management Entity
NAS Non-Access Stratum
NR New Radio/5G
PCF Policy Control Function
PCO Protocol configuration Options
PDN Packet Data Network
PDU Protocol Data Unit
PGW PDN Gateway
PGW-c PGW Control Plane
PLMN Public Land Mobile Network
QoS Quality of Service
RA Registration Area
RRC Radio Resource Control
RSD Route Selection Descriptor
SGW Serving Gateway
SIB System Information Block
SM Session Management
SMF SM Function
SMF+PGW-c Combination of SMF and PGW-c
S-NSSAI Single-Network Slice Selection Assistance Information
SOR Steering of Roaming
TA Tracking Area
TAI TA Identifier
TD Traffic Descriptor
UDM Unified Data Management
UE User Equipment
UL Uplink

### SUMMARY

According to a first aspect, a method for logical network configuration is provided. The method comprises, at an apparatus, receiving, from a mobile network entity, human readable service, HRS, information. The HRS information indicates, for at least one logical network available to the apparatus, a HRS name of a service associated with the at least one logical network. The method further comprises storing the received HRS information, and reading, from the received HRS information, the HRS name of the service associated with the at least one logical network currently used by the apparatus or available in a cell where the apparatus is camping on or that the apparatus can detect or in a tracking area or list of tracking areas or cells, or in the whole PLMN.

In some embodiments, the method further comprises displaying, either on demand or proactively, the HRS name of the service used by the apparatus.

In some embodiments, the at least one logical network is at least one of the group comprising: a network slice identified by a single network slice selection assistance information, S-NSSAI, a data network identified by a data network name, DNN, or by an access point identified as an access point name, APN, a quality of service, QoS, identified by a 5G QoS identifier, 5QI, a QoS class identifier, QCI, a traffic descriptor, TD, a route selector descriptor, RSD, or a data radio bearer, DRB, associated with explicit HRS name based on information directly provided by a session management function, SMF, via an access and mobility management function, AMF, or a packet data network, PDN, gateway, PGW, or a PGW control plane function, PGW-c, or a combined SMF and PGW-c via a SGW and MME.

In some embodiments, storing the received HRS information comprises updating HRS information stored in the apparatus with the received HRS information.

In some embodiments, the mobile network entity is one of an access and mobility management function, AMF, and a mobility management entity, MME.

In some embodiments, when the mobile network entity is an AMF, the mobile network entity further comprises one of a session management function, SMF, a policy control function, PCF, and a unified data management function, UDM.

In some embodiments, when the mobile network entity is an MME, the mobile network entity further comprises a serving gateway, SGW, and one of an SMF combined with a PGW-c and a PGW-c.

In some embodiments, the SMF combined with a PGW-c is in connection with a PCF.

In some embodiments, the method further comprises, at the apparatus, transmitting to the mobile network entity a first message.

In some embodiments, the first message is one of a registration request, a PDN connectivity request, a Bearer resource allocation request or a protocol data unit, PDU, session establishment or modification request.

In some embodiments, the first message comprises an indication of HRS information support.

In some embodiments, the method further comprises, at the apparatus, transmitting to the mobile network entity a second message acknowledging the reception of the HRS information.

In some embodiments, storing the received HRS information further comprises a security check of the received HRS information prior to the storing.

In some embodiments, wherein the mobile network entity comprises at least an AMF and a UDM, the method further comprises receiving, at the AMF from the apparatus, the first message comprising an indication of HRS information support; transmitting, from the AMF to the UDM, said first message; and receiving, at the AMF from the UDM, an acknowledgment of the reception of the first message at the UDM including HRS information.

In some embodiments, wherein the mobile network entity comprises at least an AMF and a UDM, the method further comprises transmitting, from the AMF to the UDM, the second message acknowledging the reception of the HRS information.

In some embodiments, the first message further comprises an indication request of available S-NSSAIs in the apparatus subscription data supported at least in a registration area, RA, of the apparatus, or available in a cell where the apparatus is camping on or that the apparatus can detect, or in a tracking area or list if tracking areas or cells, or in the whole PLMN.

In some embodiments, the method further comprises, at the apparatus, receiving from the mobile network entity, in response to the first message, information indicating the available S-NSSAIs from the apparatus subscription data which are supported in the registration area, RA, i.e. a list of tracking area identifiers (TAIs) within which the apparatus is not requested to register again upon mobility, of the apparatus.

In some embodiments, the received information from the mobile network entity indicates the available S-NSSAIs from the apparatus subscription data which are supported in at least the registration area, RA, of the apparatus per tracking area, TA, identifier, TAI or list of TAIs.

In some embodiments, the received information from the mobile network entity indicates the available S-NSSAIs from the apparatus subscription data which are supported in at least the registration area, RA, of the apparatus per tracking area, TA, identifier, TAI, or list of TAIs, and/or per cell identity, Cell ID, or list of Cell IDs.

In some embodiments, the received information from the mobile network entity indicates the available S-NSSAIs from the apparatus subscription data which are supported in the registration area, RA, but also in the proximity of the RA in a list of tracking areas identifiers (TAIs) which may differ from the list of TAIs in the RA of the apparatus, or in a list of cells that can be within or outside the RA.

In some embodiments, the received information from the mobile network entity indicates the available S-NSSAIs from the apparatus subscription data which are supported in the registration area, RA, but also additional information indicating they are supported across the whole PLMN or just within specific areas of service (AoS).

In some embodiments, wherein the mobile network entity comprises at least an MME, a SGW and a SMF combined with a PGW-c, the method further comprises receiving, at the MME from the apparatus, a PDN connectivity request indicating an APN and a QoS information or a Bearer resource allocation request indicating the PDN connection identifier and QoS information; transmitting, from the MME to the PGW or SMF+PGW-c via the SGW, a create session request including the APN and the QoS information indicated in the connectivity request or a Bearer resource command including an identifier of the related PDN connection and QoS information indicated in the Bearer resource allocation request; and receiving, at the MME from the PGW or SMF+PGW-c via the SGW, a create session response, or create Bearer request or an update Bearer request including protocol configuration options, PCO, indicating HRS information. Alternatively, the mobile network entity may comprise a PGW instead of the SMF combined with the PGW-c.

In some embodiments, the method further comprises transmitting, to the mobile network entity from the apparatus, a protocol data unit, PDU, session establishment or modification request, and the HRS information is received from the mobile network entity at the apparatus via a PDU session establishment or modification response.

In some embodiments, wherein the mobile network entity comprises at least an AMF, an SMF, and a PCF, the method further comprises receiving, at the AMF from the apparatus, the PDU session establishment or modification request; transmitting, from the AMF to the SMF, the PDU session establishment or modification request; transmitting, from the SMF to the PCF, a session management, SM, policy association establishment or modification request; transmitting, from the PCF to the SMF, in response to the SM policy association establishment or modification request, the HRS information; and transmitting, from the SMF to the AMF, a PDU session establishment or modification response including the HRS information.

According to another aspect, a mobile network entity is provided. The mobile network entity comprises a transmitter, a processor, and a memory with instructions which, when executed by the processor, cause the mobile network entity to send, to an apparatus, human readable service, HRS, information, the HRS information indicating, for at least one logical network available to the apparatus, a HRS name of a service associated with the at least one logical network.

According to a further aspect, an apparatus comprising a processor, a display, and a memory is provided. The memory has instructions which, when executed by the processor, cause the apparatus, when communicatively coupled to a mobile network entity, to perform a method according to the first aspect or any of the corresponding embodiments related thereto.

In some embodiments, the apparatus is one of a user equipment, UE, a baseband module, an antenna, or any combination thereof.

### BRIEF DESCRIPTION OF THE DRAWINGS

In the following, example embodiments will be described in greater detail with reference to the attached drawings, in which:

FIG. 1 visualizes a method for logical network configuration using human readable service information, according to an embodiment.

FIG. 2 shows a schematic block diagram of an example communication device;

FIG. 3 shows a schematic block diagram of an example control apparatus;

FIG. 4 illustrates an example procedure for logical network configuration and displaying human readable service information in a 5G system, according to an embodiment.

FIG. 5 depicts a similar example procedure according to an embodiment, where the human readable service information is not proactively triggered.

FIG. 6 shows an example procedure according to an embodiment, where the UE is allowed to detect supported NSSAIs in the RA and display this information.

FIG. 7 is a flow chart illustrating the UE behavior associated to the detection of services that are already being used by the UE or could be used by the UE.

FIG. 8 shows the UE behavior in the cell with example of detection of supported network slices.

FIG. 9 visualizes the method in the EPS standard.

FIG. 10 depicts a bearer activation method for the logical network configuration method involving human readable service information in EPS standard.

FIG. 11 shows the bearer activation method initiating from the network in EPS standard.

FIG. 12 visualizes the method for displaying human readable service information in a mixed EPS/NR scenario.

### DETAILED DESCRIPTION

As mentioned above, the support of logical networks in the 5G system offers some new possibilities for the user of mobile communication devices or User Equipment (UE). For example, for distributed applications, a logical network binds the distributed components, more or less, as a single group or a single entity. In this way, logical components can be arranged into groups that represent specific services or categories for a user that may be used for a specific purpose or the user is currently using. This network slicing assumes a central role to support 5G mobile networks.

Although network slicing is distributed in such 5G communication devices, it is not possible to detect what logical network or network slice a UE is using actively. The purpose of the present subject is to enable operators to provide more visibility and control to the user of the offered service environment. More particular, the purpose is to enable the detection of service availability and usage in the UE environment. It should be understood that the end user does not get involved with the knowledge of the exact logical network identifiers (S-NSSAI, DNNs) used in the 5G system protocols, hence it is the operator which will provide the ability to associate S-NSSAIs or even DNNs activated in a S-NSSAI to a certain service experience. Yet even more particular, it should be possible also to provide the operator with means that enable the identification in the UE of the services that are available in the neighborhood, services the UE is registered with but unused, services the UE is registered with and actively being used, and associate to each a possible UI strategy.

In the following, the invention will be described by means of embodiments and corresponding figures and highlight different aspects in each embodiment. The invention includes several aspects, namely options for configuring a UE with a mapping of S-NSSAI (or S-NSSAI and a DNN) or groups of S-NSSAIs to a service name, or APN, or a combination or of this information with quality of service, QoS, or an association of a service name with the traffic descriptor, TD, or route selection descriptor, RSD, in the UE route selection policies, URSPs, provisioned in the UE, by means of information passed by the AMF to the UE and options for the identification of which services are available in the cell so the UE can be potentially triggered into registration.

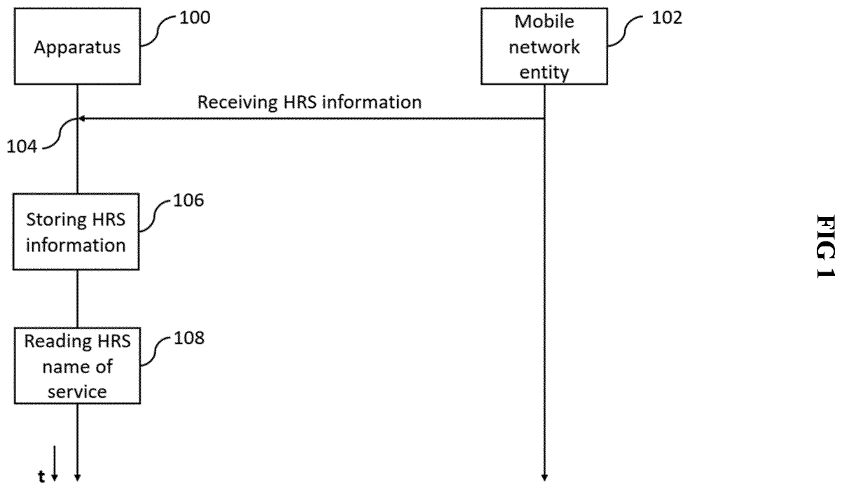

In FIG. 1, the method in the most basic setup is shown in which a mobile communication device or apparatus 100 and a mobile network entity 102 are communicating and providing all the necessary information for this method. Note that the apparatus 100 is in RRC ACTIVE state while communicating with the mobile network entity 102.

At first, in 104, the apparatus is receiving, from the mobile network entity 102, human readable service (HRS) information for a service that the apparatus 100 is using or that is available to the apparatus 100. For example, a user of a mobile communication device 100 could be interested in identifying the available services, or an operator of a mobile communication network could be interested in signaling the user which services are available. The HRS information indicates, for at least one logical network that is available to the apparatus 100, a HRS name of a service associated with the at least one logical network. The HRS information is provided by any mobile network entity 102 that can communicate with the apparatus and knows the assignment of the logical networks of the apparatus and the physical network components. The logical network may be any kind of network slice or Quality of Service (QoS) that the user is interested in and the apparatus is able to serve.

Next, at 106, the apparatus 100 is storing the received HRS information to be used for any service the apparatus 100 is running. The HRS information, or a component thereof, may be stored in a non-volatile memory for long term usage within the communication with the mobile network entity 102 or the information may be stored temporarily for the current service or for a single usage (e.g. when an HRS information item is provided corresponding to an establishment of a data radio bearer or data session that has a lifecycle from establishment to tear down, or, for example, a when the HRS information item is passed to the UE by the mobile network at a registration with one or a set of S-NSSAIs that has a lifecycle from the this registration procedure to a registration procedure when the set of S-NSSAI changes or a certain S-NSSAI is no longer registered).

Lastly, at 108, the apparatus 100 is reading, from the received HRS information, the HRS name of the service used by the apparatus 100. With this information, the apparatus 100 is now able to, e.g., display the current service name of a service that is assigned to a logical network/network slice. With this, there are two areas of improvement in the whole displaying system of an apparatus. For one, the apparatus offers the ability to display what logical network or set of logical networks are actively used and thus constituting a certain service profile usage indication for the user. The other is to enable the user to opt into one of possible service environments enabled by one or more of such logical networks to enable the execution of certain applications or services only.

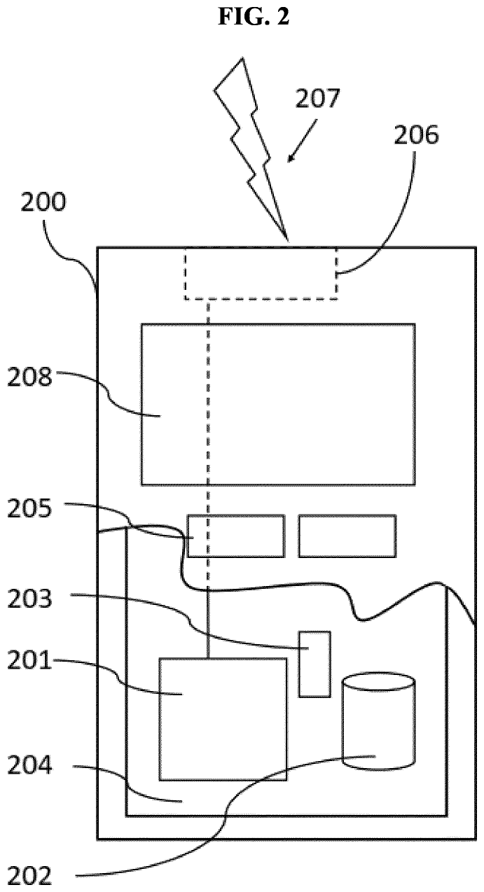

A possible (mobile) communication device 200 will now be described in more detail with reference to FIG. 2 showing a schematic, partially sectioned view. Such a mobile communication device 200 is often referred to as User Equipment (UE), user device or terminal device. An appropriate mobile communication device 200 may be provided by any device capable of sending and receiving radio signals. Non-limiting examples comprise a Mobile Station (MS) or mobile device such as a mobile phone or what is known as a smart phone, a computer provided with a wireless interface card or other wireless interface facility (e.g., USB dongle), Personal Data Assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more Global Navigational Satellite Systems (GNSS such as GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be (communicatively) coupled (e.g., directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an Application Specific Integrated Circuit (ASIC), a Field Programmable Gate Array (FPGA), and/or the like, or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various 3rd Generation (3G) communication protocols, 4th generation (4G) communication protocols, 5th Generation (5G) communication protocols, Internet Protocol Multimedia Subsystem (IMS) communication protocols such as, for example, Session Initiation Protocol (SIP) and/or the like, or 5G beyond. For example, the communication device 200 may be capable of operating in accordance with 4G wireless communication protocols, such as LTE-A, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder, an internal data modem, and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as Wireless Application Protocol (WAP), HyperText Transfer Protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless Universal Serial Bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or WLAN modem may also be capable of transmitting and/or receiving data from electronic devices according to various wireless networking techniques, including 6LoWPAN, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more Embedded Universal Integrated Circuit Cards (eUICCs), one or more Universal Integrated Circuit Cards (UICC), and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

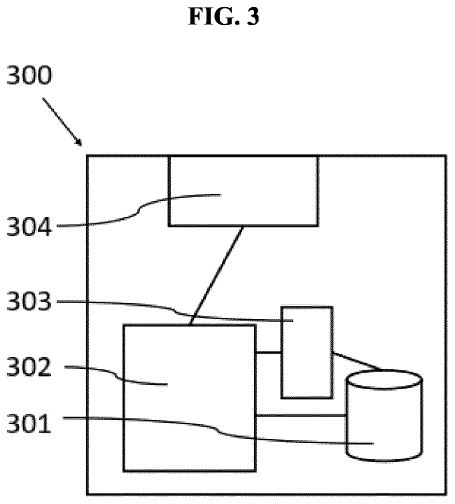

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 3, computer-readable medium may comprise a non-transitory computer-readable storage medium that may be any media that can contain or store the instructions for use by or in connection with an instruction execution system, apparatus, or device, such as a computer.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio for a RAN (e.g. to reach and communicate with a serving cell). A UE may generate and transmit and receive RRC messages containing one or more RRC PDUs (Packet Data Units).

The UE may have different states (e.g. according to 3GPP TS 38.331) sections 42.1 and 4.4, incorporated by reference). A UE is e.g. either in RRC_CONNECTED state or in RRC INACTIVE state when an RRC connection has been established.

In RRC_CONNECTED state a UE may store the AS (access stratum) context, transfer unicast data to/from the UE, monitor control channels associated with the shared data channel to determine if data is scheduled for the data channel, provide channel quality and feedback information, perform neighboring cell measurements and measurement reporting.

In some embodiments, the communication device 200 (i.e., UE or a user device in a network) comprises the processor (e.g., the at least one data processing entity 201) and the memory (e.g., the at least one memory 202). The memory includes computer program code causing the communication device 200 to perform processing according to the methods described below.

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. For example, the control apparatus 300 may be coupled to and/or for controlling the mobile network entity 102. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as an RNC or a spectrum controller. In some embodiments, a base station may have such a control apparatus as well as a control apparatus being provided in an RNC. The control apparatus 300 can be arranged to provide control on communications in the service area of the system. The control apparatus 300 comprises at least one memory 301, at least one data processing unit 302, 303 and an input/output interface 304. Via the interface the control apparatus 300 can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. A processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more microprocessor associated with a DSP core, a controller, a microcontroller, ASICs, FPGA circuits, and other type of integrated circuits (ICs), and/or state machines.

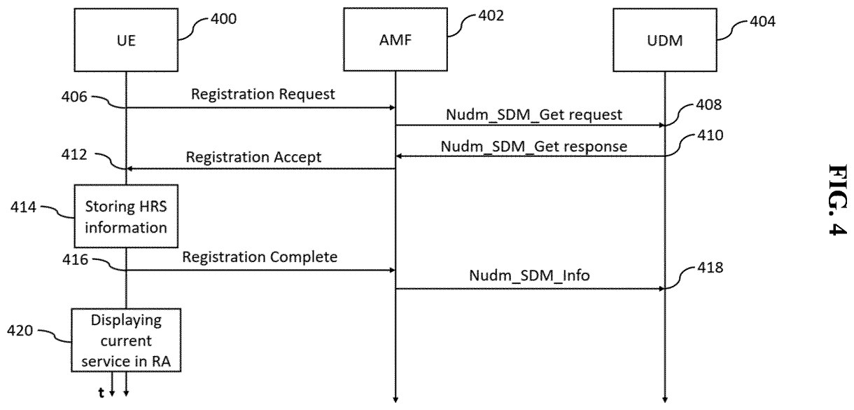

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIGS. 1 and 4 et seq.

In FIG. 4, an embodiment of the method for logical network configuration and displaying HRS information in a 5G system is shown. The apparatus 100 is now shown as a UE 400 and the mobile network entity 102 is shown as Access and Mobility Management Function (AMF) 402 and Unified Data Management (UDM) 404 from CN side. Alternatively, the mobile network entity 102 may include a Policy Control Function (PCF) instead of the UDM 404.

At first, a Registration Request 406 is transmitted from the UE 400 to the mobile network entity 102. With the Registration Request 406, the UE 400 may indicate support of HRS information (HRSI) to the AMF 402. The UE 400 may indicate HRS information support in a container for the UDM 404. When the UE 400 enters a new cell that is not in the RA or not in a list of cells where the allowed S-NSSAIs are known to be supported, then the UE 400 is indicating the HRSI support within the Registration Request. This HRS information can also be sent to the UE as a UE configuration updated proactively.

For whatever reason the UE 400 indicates the HRSI support in a Registration Request, the AMF 402 relays this indication to the UDM 404 in a Nudm_SDM_Get_request 408 when it requests subscription data.

Next, the UDM 404 may acknowledge the indication of HRSI support and send the HRS information via a Nudm_SDM_Get response 410 back to the AMF 402, e.g. as part of a SOR container.

The AMF 402 provides in the Registration Accept 412 the HRS information received from the UDM 404 to the UE 400. Additionally, if the availability of service indication is supported by the AMF 402, also the list of the subscribed S-NSSAIs available in the RA per TA is sent to the UE 400. More specifically, the UE 400 receives all available service indications the RA so that every available service may be assigned with HRS information.

The UE 400 then stores the received HRS information at 414, possibly after any security check of the received information from the UDM 404.

In 416, the UE 400 acknowledges the reception of HRSI in a Registration Complete message back to the AMF 402 with a container addressed to the UDM 404.

The AMF 402 then provides the container for UDM 404 in a Nudm_SDM_Info operation message 418.

Finally, at 420, the UE 400 reads, from the HRSI, the service names and displays the services currently active and, e.g. on demand, those services that are available in the cell or TA or even RA based on the received information.

The HRS information is structured in the following table, where the service name is a placeholder for any service identification string that is human readable.

| | Human Readable | | Example of configurable |
|---|---|---|---|
| Service description | Service Name | System applicability | Conditions of display |
| S-NSSAI x | Service name 1 | 5GS only, EPS only, | At any time if S-NSSAI |
| | | both EPS, 5GS | registered or If active in |
| | | | last x seconds, |
| | | | (proactive) |
| (S-NSSAI, DNN) or | Service name 2 | 5GS only, EPS only, | At any time if DNN |
| matching APN | | both EPS, 5GS | session established/if |
| | | | session active in last X |
| | | | seconds (on demand, |
| | | | proactive) |
| (S-NSSAI, DNN, 5QI | Service name 3 | 5GS only, EPS only, | At any time if DRB |
| (EPS mapping QCI)) | | both EPS, 5GS | active/If DRB active in |
| | | | last X seconds (on |
| | | | demand(e.g. within a |
| | | | swipe down menu) or |
| | | | proactively (e.g. next to |
| | | | a network ID on |
| | | | display)) |
| (S-NSSAI, 5QI | Service name 3 | 5GS only, EPS only, | At any time if DRB |
| (EPS mapping QCI)) | | both EPS, 5GS | active/If DRB active in |
| | | | last X seconds |
| | | | (on demand, proactive) |
| (5QI (and EPS mapping | Service name 3 | 5GS only, EPS only, | At any time if DRB |
| QCI)) | | both EPS, 5GS | active/If DRB active in |
| | | | last X seconds |
| | | | (on demand) |
| Group of S-NSSAIs | Service name 4 | 5GS only, EPS only, | At any time/if used in |
| | | both EPS, 5GS | the last X seconds |
| | | | (on demand) |
| Traffic Descriptor (see | Service name 5 | 5GS only, EPS only, | At any time proactively |
| 23.503) and/or Route | | both EPS, 5GS | (e.g. next to a network |
| selector descriptor | | | ID on display) |
| Information the SMF or | Service name 6 | 5GS only, EPS only, | Display on demand |
| SMF + PGW-c provide to | | both EPS, 5GS | (e.g. within a swipe |
| the UE based on the PDN | | | down menu) |
| connection/PDU session | | | |
| state (including SM events | | | |
| that result in activation or | | | |
| modification of DRBs) | | | |

each of the entries may be further associated to a “retention” policy in storage (e.g. permanent, or for the duration of the DRB establishment etc.)

In the table, there are service description rules that result in displaying the used services names according to some indicated policies including also whether the display applies to 5G only, EPS (4G) only or is applicable to both systems.

If, e.g., the User is interested in identifying the services in the cell that are available, then the UE 400 can identify the S-NSSAIs available in the TA of the current cell if the AMF 402 provided the information of the S-NSSAIs in subscription available in RA per TA Identifier (TAI), and match the rules based on this information.

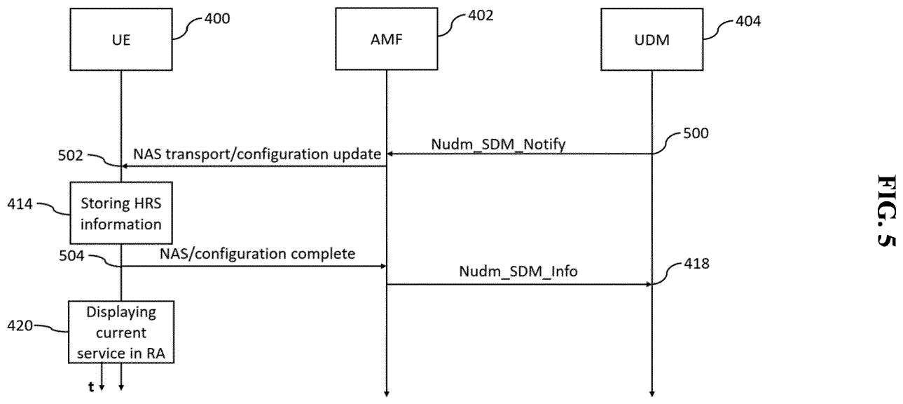

FIG. 5 represents an embodiment where the HRSI configuration of the UE is updated by the network and is not proactively triggered by the UE 400, so the CN is sending the information to the UE independently from receiving a message from the AMF serving the UE.

The UDM 404 sends a Nudm_SDM_Notify message 500 to the AMF 402 to indicate HRS information to the UE 400. As explained above, this message can be sent as a SOR container or it could also be part of the subscription information provided to the UE.

The UE 400 may then receive from the AMF 402 via downlink (DL) Non-Access Stratum (NAS) transport or via UE configuration update message 502 the HRS identification information and/or the available S-NSSAIs from the apparatus subscription data which are supported in the registration area, RA, of the apparatus per (list of) tracking area, TA, identifier, TAI, and/or per (list of) cell identities (Cell ID)

As before, the UE 400 stores the HRS information at 414, possibly after a security check, and provides an acknowledgment via uplink (UL) NAS transport message or UE configuration update complete message 504. The choice between DL/UL NAS transport or UE configuration update procedure depends on whether the information is part of a container from the UDM 404 or part of the subscription info. The Container approach reusing SOR information advantage is that it requires no explicit AMF 402 support to handle new information elements or logic linked to HRS information handling. If the AMF 402 is not supporting the indication of slices available in the proximity of the cell/TA where the UE is camping, however, then the UE 400 may be unable to get the information necessary to check what services are available in the RA or RA and proximity of the RA.

After that, the method follows the same activities as in FIG. 4, where the AMF 402 provides the container for UDM 404 in a Nudm_SDM_Info operation message 418 and the UE 400 is reading the HRSI and displays the services currently active 420 and can display those services that are available in the cell or TA or even RA based on the received information and policies related to the display of the active services.

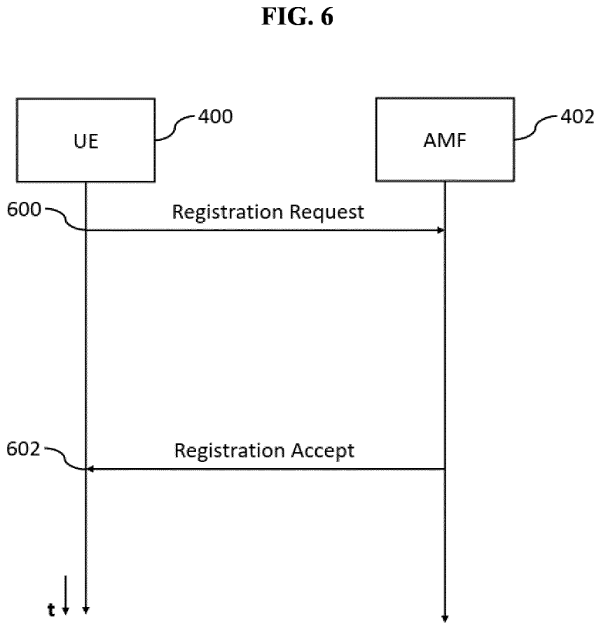

It should be noted also that once the UE 400 has been provisioned with the information on HRSI, it can however be interested in detecting the available S-NSSAI in the RA. To do so it could separately request this information to be provided as per FIG. 6 described herein below.

FIG. 6 highlights the process of allowing the UE 400 to detect the supported S-NSSAIs in the RA by showing only the messages between the UE 400 and the AMF 402. This time, the Registration Request 600 includes an indication requesting information of the S-NSSAIs supported in the RA and its proximity.

The Registration Accept 602 then transmits all available S-NSSAIs in subscription data of the UE that are available in the RA of the UE or per (list of) TAI(s), or per (list of) cell identitie(s) (Cell ID(s))

Note that, it is also possible that some services are not supported in the whole RA, and therefore the AMF shall provide the TAI where they are not supported or where they are supported. In short, once the UE 400 obtains this information, it can use it to provide the user with information of potentially available services in the cell where it is camping.

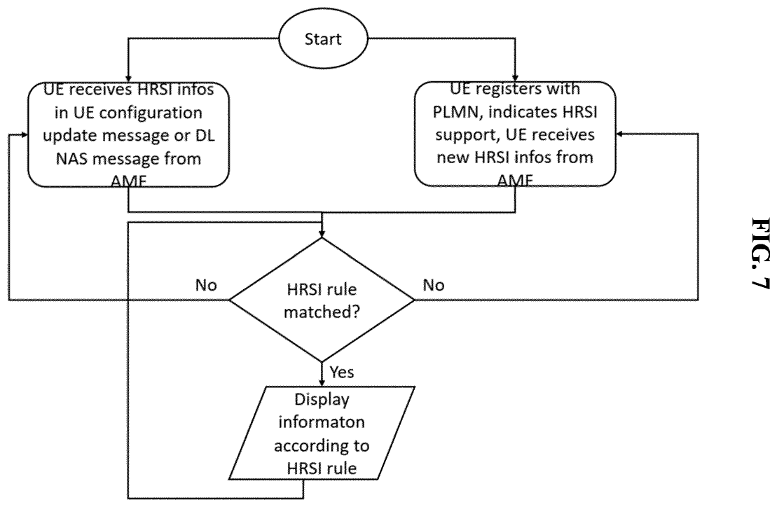

The UE behavior associated to the detection of services that are already being used by the UE 400 or could be used by the UE 400 in current cell or in neighboring cells (e.g. by reading the System Information Block (SIB) about or of neighbor cells) is summarized by the following embodiment, depicted by a flow diagram in FIG. 7.

In FIG. 7, starting on the right path, the UE registers with a Public Land Mobile Network (PLMN) and indicates proactively that it supports HRSI. Therefore, the UE receives and stores new configuration for HRSI in a Registration Accept message (i.e. sent from the AMF). Otherwise, starting on the left path, the UE may also already have previous HRSI configuration. In this case, the UE receives and stores new HRSI configuration in a UE configuration update message or a DL NAS transport message from AMF reactively.

Next, regardless of how the UE received the HRSI, the UE has to decide if any HRSI rule is matched with a provided service considering the local environment information at the UE. The local environment information can include the allowed S-NSSAIs, established PDU sessions, SIB information, the access network that is being used, the QoS parameters of a DRB etc. If it is no HRSI item is matched, no service information is displayable at the UE. The UE may receive at any time new or updated configuration for the HRSI.

If any HRSI rule is matched with a service, e.g. streaming, then the UE can display the information according to the HRSI rule. If the service changes, e.g. instead of streaming the user is now gaming, then the UE decides again if any HRSI rule is matched now with this service and repeats the procedure as described above. In case the UE is moving, the UE may cross the RA boundary and upon executing the mandatory Mobility Registration update procedure, it can obtain any updated HRSI in the Registration Accept message.

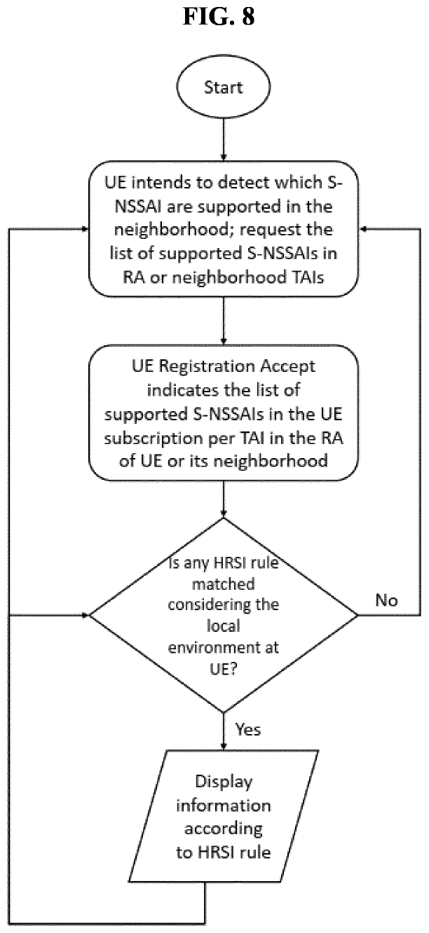

The following flow diagram in FIG. 8 is related to the UE detection of supported services in the cell (not necessarily in use already by the UE) with example of detection of supported network slices.

Starting on top, the UE intends to detect which S-NSSAIs are supported in the neighborhood (e.g. in the RA), and requests the list of supported S-NSSAIs in the RA or neighborhood TAIs in a Registration Request.

Next, the AMF or any other mobile network entity communicating with the UE is sending a Registration Accept which indicates the list of supported S-NSSAIs in the UE subscription data available in the RA of the UE or per (list of) TAI(s), or per (list of) cell identitie(s) (Cell ID(s)) in the RA of UE or its neighborhood.

Then, in the decision box, the UE has to check, as before in FIG. 7, whether any HRSI rule is matched with a provided service considering the local environment information at the UE, e.g. TAI or Cell ID, in System Information Block Type 1 (SIB1).

In case there are no matches found between any HRSI and available S-NSSAI, the UE can be ready to re-evaluate any new information it may receive again in a configuration update or DL NAS transport message. Otherwise, the UE can display the information according to the HRSI rule.

Again, if the UE is changing the service or moving away from the cell or TA, the UE then has to check again whether any HRSI rule is matched or request again a list of supported S-NSSAIs in the neighborhood.

The detection of a supported service may be used for diagnostic or for trigger of specific marketing policies for operators (e.g. advertising the availability of superfast gaming so gamers can be aware they are in an area where their gaming experience is enhanced and be satisfied they benefit from the subscribed service as advertised).

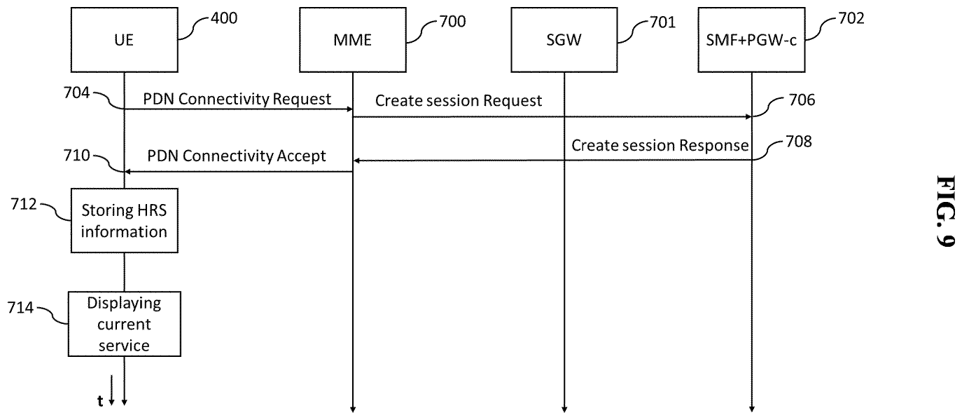

The following FIG. 9 shows an embodiment, which provides means by which human readable service (HRS) identification information can be provided in the Evolved Packet System (EPS/4G). More particular, the HRSI can be provided by Protocol Configuration Options (PCO) information over the EPS. In this embodiment, the mobile network entity comprises at least a Mobility Management Entity (MME) 700, a Serving Gateway (SGW) 701 and a PDN Gateway (PGW) or a PGW Control Plane Function (PGW-c) or Session Management Function (SMF) combined with the PGW-c (SMF+PGW-c) 702.

In this embodiment, the UE 400 sends a Packet Data Network (PDN) Connectivity Request 704 to the MME 700 including an Access Point Name (APN) and Quality of Service (QoS) for this connection establishment.

The MME 700 forwards the PDN Connectivity Request in a Create Session Request 706 to the SMF+PGW-c 702 (or PGW) via the SGW 701.

The SMF+PGW-c 702 (or PGW), possibly after interaction with a Policy Control Function (PCF) 1002 exchanging Session Management (SM) policy association establishment/modification messages 1008 and 1010, then responds with a Create Session Response 708 sent to the MME 700 via the SGW 701, including PCO information which include HRS identification information and also the available S-NSSAIs.

The MME 700, again, forwards this information in a PDN Connectivity Accept message 710 including the PCO information indicating HRS information.

The UE 400 then stores the received HRSI in the PCO information, at 712, and can finally display the active service proactively or on demand based on the HRSI configuration received in the PCO, at 714.

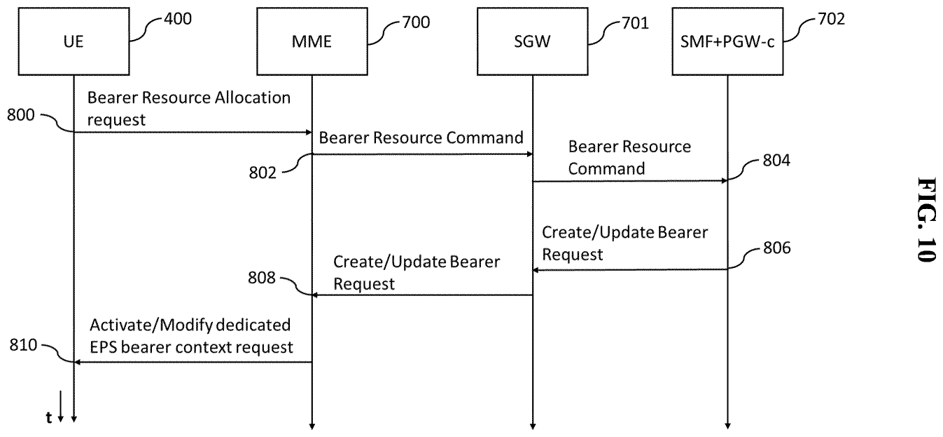

In a further finer embodiment, shown in FIG. 10, the UE initiates a bearer activation method for the logical network configuration. Note that, this procedure may proceed in parallel to the embodiment described in FIG. 9.

In this embodiment, the mobile network entity comprises at least an MME 700, a SGW 701 and a PGW (or PGW-c) or SMF+PGW-c 702. At first, the MME 700 receives from the UE 400, a Bearer resource allocation request 800 including an identifier of the related PDN connection (as shown in FIG. 9) and a QoS specification for the bearer.

Next, the MME 700 transmits to the SGW 701 and then the SGW to the PGW or SMF+PGW-c 702, a Bearer resource command 802 and 804 including an identifier of the related PDN connection and a QoS specification for the bearer.

Then, in response to the Bearer resource command, the MME 700 receives from the PGW or SMF+PGW-c 702 via the SGW 701, a create bearer request 806 and 808 or (in case this was a modification of QoS) an update bearer request including protocol configuration options, PCO, indicating HRS information. The MME 700 then proceeds to send to the UE 400 an Activate dedicated EPS bearer context request 810 or (in case this was a modification of QoS) an Modify EPS bearer context request including protocol configuration options, PCO, indicating HRS information.

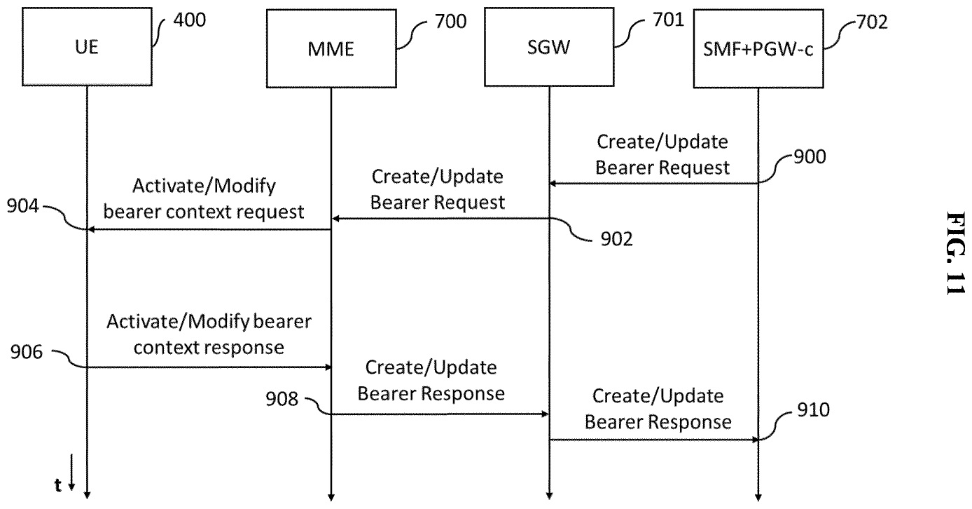

In EPS standard and in case the HRS information is sent via the network without a trigger from the UE, as analogously described in FIG. 5, then the bearer may be created or updated via the network as shown in FIG. 11.

In this embodiment, the mobile network entity comprises at least an MME 700, a SGW 701 and a PGW (or PGW-c) or SMF+PGW-c 702. In other embodiments, an eNB might also be present between the communication path of the UE 400 and the MME 700. Starting from the PGW (or PGW-c) or SMF+PGW-c 702 with a create Bearer request (in case this was a modification of QoS) or an update Bearer request 900 and 902 sent to the MME 700 via the SGW 701 including protocol configuration options, PCO, indicating HRS information.

The MME 700 then proceeds to send to the UE 400 an Activate dedicated EPS bearer context request or (in case this was a modification of QoS) a Modify EPS bearer context request 904 including protocol configuration options, PCO, indicating HRS information.

In the same manner, the corresponding responses are sent. The Activate bearer context response (in case this was a modification of QoS) or the Modify bearer context response 906. The create or update bearer Response 908 and 910 is then sent from the MME 700 via the SGW 701 to the PGW (PGW-c) or SMF+PGW-c 702.

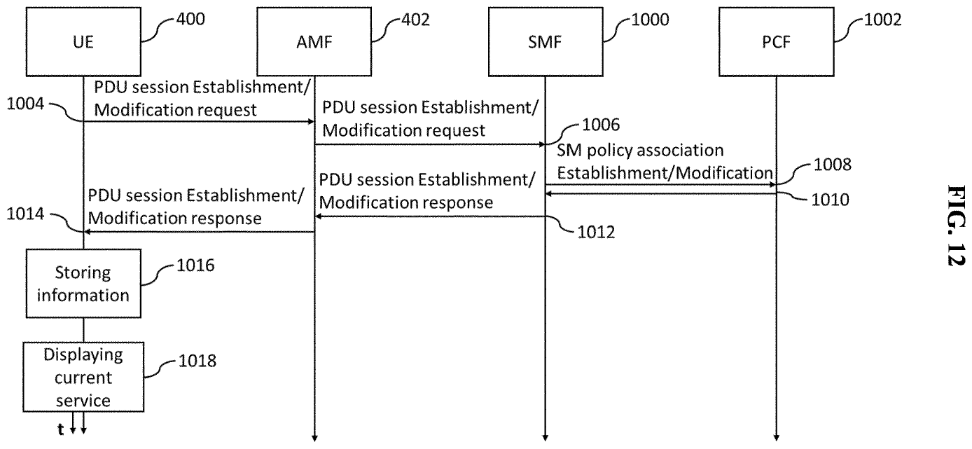

Following the same principle above, the HRSI can be directly provided to the UE per specific session management interaction to identify the services that the specific session management interaction activates. FIG. 12 depicts such an embodiment and will be described in the following.

In this embodiment depicted in FIG. 12, the UE 400 sends a Protocol Data Unit (PDU) Session Establishment or Modification Request 1004 (depending on the current UE state) to the AMF 402.

The AMF 402 forwards this message with a further PDU Session Establishment or Modification Request 1006 to the SMF 1000.

The SMF 1000 and the Policy Control Function (PCF) 1002 can exchange Session Management (SM) policy association establishment/modification messages 1008 and 1010, so the SMF can obtain HRS identification information provided by the PCF. Otherwise, the SMF may apply locally configured HRS information.

Following this step, the SMF 1000 sends a PDU Session Establishment/Modification Response 1012 back to the AMF 402 including the received HRS identification information.

The UE 400 receiving this PDU Session Establishment/modification Response 1014 from the AMF 400, stores, at 1016, the received HRS information for the Data Radio Bearer (DRB) of the SM transaction.

Consequently, the UE 400 can display the active service associated with this DRB of the SM transaction proactively or on demand based on the configuration received

In this case, the information can be sent by SMF in the PCO or, differently from EPS case involving the MME, SGW and SMF+PGW-c, in a new information element.

### Examples

In the following, some non-limiting examples for the applicability of the above disclosed methods will be presented. These examples are merely intended to illustrate the disclosed subject matter. Note that this list of examples is neither exclusive nor exhaustive.

In a first example, a subscriber has the S-NSSAI of a network slice in the subscription information, which may be stored, e.g., in the UE. The network slice may have a limited area of service. That is, the services associated with that network slice may not be available in each cell or each TA. However, the UE may be configured to always request the slice at every mobility registration update (MRU). In this case, the disclosed methods enable the user to detect when the UE is served by the network slice, as the UE will display the human readable name of the network slice (e.g., next to the 5G Icon) and therefore safely operate the relevant network slice applications. The network operator can configure the condition for display to be at any time if the UE is S-NSSAI registered.

In a second example, the user has subscribed to a particular service package (e.g., a gaming service package) offering a particular (e.g., gaming) quality performance slice/QoS in the subscription information. Again, the service may not be available everywhere, or the operator may be interested to signal to the package users that the particular service capability (e.g., gaming capability) is available to the UE. As above, the UE may be configured to always request the slice at every mobility registration update (MRU). In this case, the disclosed methods enable the user to detect when the UE is served by the particular slice (e.g., gaming slice) as the UE will display the human readable name of that slice (e.g., could be like a “game” text next to the 5G Icon or an icon that translated the text game into a symbol conveying the semantic of gaming, e.g. a game controller icon) and therefore initiate the corresponding sessions (e.g., gaming sessions) when this is available. This icon may be configured to not be available in 4G systems, so that, if the UE moves to 4G, this icon disappears. Users will then be aware of 5G enabling that particular service (e.g., gaming), which may act as incentivizing 5G service packages.

In a third example, XR services can be enjoyed via certain sessions at the edge and using certain special QoS and slice being available for these connections. In this case, the UE may be configured to indicate “XR” availability on the display next to the 5G icon when it can connect to the edge with the required QoS and slice. Users may then actually use XR apps only when they see this indication on the display.

In a fourth example, a user may experience some service issues. The network operator has provided, for each connectivity option identified by a route selection descriptor, RSD in UE Route Selection Policy (URSP) that the user can use, a human readable service name (HRSN). The user may then call the helpdesk, and the helpdesk may ask the user to, e.g., swipe down the control panel on the device where all the active services names are displayed (e.g. is the bearer set for XR active? if not, it means the user is experiencing best effort XR without any special handling by the network). The user can then read out the names of the services that are active, and the helpdesk can detect which one is not active and guide the user to recovery actions.

In a fifth example, where a user again experiences some service issues, the user may swipe down the control panel on the device where all the active services names are displayed. When the user does not see the service it has subscribed to, the user can call helpdesk with already some diagnostic information available.

In a sixth example, a UE establishes or modifies a session in EPS or 5GS to enjoy a certain application which supports specific QoS. In this case, an SMF-either alone or in connection with a PGW-c or a PGW-provides within the PCO (Protocol Configuration Option) in the Session management “Accept” message a HRSI that indicates the display name of the active connectivity that is established. The user can then detect that this is established, e.g., for use by the network operator or for diagnostic type of use cases.

It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1-27. (canceled)

28. An apparatus comprising: at least one processor; and at least one memory storing instructions that, when executed by the at least one processor, cause the apparatus at least to perform: receiving, from a mobile network entity, human readable service, HRS, information, the HRS information indicating, for at least one logical network available to the apparatus, a HRS name of a service associated with the at least one logical network: storing the received HRS information: reading, from the received HRS information, the HRS name of the service associated with the at least one logical network currently used by the apparatus or available in a cell where the apparatus is camping on or that the apparatus can detect, or in a tracking area or list of tracking areas or cells, or in the whole PLMN.

29. The apparatus of claim 28, wherein the apparatus is further caused to perform: displaying, either on demand or proactively, the HRS name of the service used by the apparatus.

30. The apparatus of claim 28, wherein the at least one logical network is at least one of the group comprising: a network slice identified by a single network slice selection assistance information, S-NSSAI, a data network identified by a data network name, DNN, or by an access point identified an access point name, APN, a quality of service, QoS, identified by a 5G QoS identifier, 5QI, a QoS class identifier, QCI, a traffic descriptor, TD, a route selector descriptor, RSD, or a data radio bearer, DRB, associated with explicit HRS name based on information directly provided by a session management function, SMF, via an access and mobility management function, AMF, or a packet data network, PDN, gateway, PGW, or a PGW control plane function, PGW-c, or a combined SMF and PGW-c, via a SGW and MME.

31. The apparatus of claim 28, wherein storing the received HRS information comprises updating HRS information stored in the apparatus with the received HRS information.

32. The apparatus of claim 28, wherein the mobile network entity is one of an access and mobility management function, AMF, and a mobility management entity, MME.

33. The apparatus of claim 32, wherein, when the mobile network entity is an AMF, the mobile network entity further comprises one of a session management function, SMF, a policy control function, PCF, and a unified data management function, UDM.

34. The apparatus of claim 32, wherein, when the mobile network entity is an MME, the mobile network entity further comprises a serving gateway, SGW, and one of an SMF combined with a PGW-c and a PGW-c.

35. The apparatus of claim 34, wherein the SMF combined with a PGW-c is in connection with a PCF.

36. The apparatus of claim 28, wherein the apparatus is further caused to perform: transmitting to the mobile network entity a first message.

37. The apparatus of claim 28, wherein the first message is one of a registration request, a PDN connectivity request, a Bearer resource allocation request or a protocol data unit, PDU, session establishment or modification request.

38. The apparatus of claim 37, wherein the first message comprises an indication of HRS information support.

39. The apparatus of claim 28, wherein the apparatus is further caused to perform: transmitting to the mobile network entity a second message acknowledging the reception of the HRS information.

40. The apparatus of claim 28, wherein storing the received HRS information further comprises a security check of the received HRS information prior to the storing.

41. The apparatus of claim 37, wherein the first message further comprises an indication request of available S-NSSAIs in the apparatus subscription data supported at least in a registration area, RA, of the apparatus, or available in a cell where the apparatus is camping on or that the apparatus can detect, or in a tracking area or list of tracking areas or cells, or in the whole PLMN.

42. A mobile network entity, comprising: at least one processor; and at least one memory storing instructions that, when executed by the at least one processor, cause the mobile network entity at least to perform: sending, to an apparatus, human readable service, HRS, information, the HRS information indicating, for at least one logical network available to the apparatus, a HRS name of a service associated with the at least one logical network.
